(19) United States
(12) Patent Application Publication
(10) Pub. No.: US 2019/0202229 A1
(43) Pub. Date: Jul. 4, 2019

(54) LINE SEGMENT CODE FOR EMBEDDING INFORMATION

(71) Applicant: Idemia Identity & Security USA LLC, Billerica, MA (US)

(72) Inventors: Robert L. Jones, Andover, MA (US); Yecheng Wu, Lexington, MA (US); Daoshen Bi, Boxborough, MA (US); Robert Andrew Eckel, Andover, MA (US)

(21) Appl. No.: 16/236,969

(22) Filed: Dec. 31, 2018

Related U.S. Application Data
(60) Provisional application No. 62/612,342, filed on Dec. 30, 2017.

(51) Int. Cl. B42D 25/435; G06K 9/00; G06K 9/68; B42D 25/23; B42D 25/373; B42D 25/324

(52) U.S. Cl. CPC B42D 25/435; G06K 9/00442; B42D 25/324; B42D 25/23; B42D 25/373; G06K 9/68

(57) ABSTRACT

Methods, systems, and apparatus, including computer programs encoded on a computer storage medium, for identifying one or more layers of a document, where at least one layer is an inner layer having a particular depth; determining a spectral feature from among multiple spectral features for application to the one or more layers of the document; determining a particular type of line segment code for application to the one or more layers of the document; and generating an identification document by: i) applying the spectral feature; and ii) applying the particular type of line segment code to the inner layer having the particular depth, wherein the particular depth is determined relative to at least one other layer of the document.

### CROSS-REFERENCE TO RELATED APPLICATION

This application claims the benefit of U.S. Provisional Patent Application No. 62/612,342, entitled “LINE SEGMENT CODE FOR EMBEDDING INFORMATION,” filed on Dec. 30, 2017, and Attorney Docket Number 37689-0512P01. The entire disclosure of U.S. Provisional Application No. 62/612,342 is expressly incorporated by reference herein in its entirety.

This application is related to U.S. patent application Ser. No. 15/808,628, entitled “EMBEDDING SECURITY INFORMATION IN AN IMAGE,” filed on Nov. 9, 2017, and Attorney Docket Number 37689-0490001. The entire disclosure of U.S. patent application Ser. No. 15/808,628 is expressly incorporated by reference herein in its entirety.

This application is related to U.S. Provisional Patent Application No. 62/611,504, entitled “LINE SEGMENT CODE FOR EMBEDDING INFORMATION IN AN IMAGE,” filed on Dec. 28, 2017, and Attorney Docket Number 37689-0509P01. The entire disclosure of U.S. Patent Application No. 62/611,504, is expressly incorporated by reference herein in its entirety.

This application is related to U.S. Provisional Patent Application No. 62/611,871 entitled “PIXELATION DENSITY INCREMENT FOR EMBEDDING INFORMATION,” filed on Dec. 29, 2017, and Attorney Docket Number 37689-0511P01. The entire disclosure of U.S. Patent Application No. 62/611,871, is expressly incorporated by reference herein in its entirety.

### FIELD

This specification relates to line segment code for embedding information in a card or document.

### BACKGROUND

User identifications such as driver licenses can be issued either as physical identification cards or digital identifications. A physical identification card is issued by creating a card that includes customer or cardholder information, whereas a digital identification is issued in an electronic format and accessed using a client device. Both physical and digital identifications are commonly used for verifying the identity of an individual, providing access to restricted areas, or authorizing an individual to purchase age-restricted content.

### SUMMARY

This specification describes techniques for using various types of line code segment technology to embed encoded information at a physical or digital card (e.g., an identification card). In particular, this disclosure describes ways of using line code segment code technology to embed information. The described methods involve layering line code patterns into a credential document (physical or digital) or combining line patterns with certain laser engraving processes (e.g., Lasink technology). A variety of different types of line patterns and line segments can be selected, arranged, and configured to encode data by applying certain line code features that are ascribed to numerical or letter values. Methods and options are described for embedding user credential data in which the line code technology can be extended to provide additional options for encoding and embedding sensitive data in a document or identification card.

One aspect of the subject matter described in this specification can be embodied in a computer-implemented method. The method includes identifying one or more layers of a document, where at least one layer is an inner layer having a particular depth; determining a spectral feature from among multiple spectral features for application to the one or more layers of the document; and determining a particular type of line segment code for application to the one or more layers of the document, the line segment code being configured to encode credential data about an individual. The method further includes generating an identification document by: i) applying the spectral feature; and ii) applying the particular type of line segment code to the inner layer having the particular depth. The particular depth is determined relative to at least one other layer of the document.

These and other implementations can each optionally include one or more of the following features. For example, in some implementations, applying the spectral feature includes: applying the spectral feature at an edge of the identification document to create an edge feature based on an edge contour and an edge cut of the identification document. In some implementations, generating the identification document includes sensitizing an edge of the identification document to create a sensitized edge surface that is conditioned to receive the spectral feature; and applying the spectral feature and the particular type of line segment code to the sensitized edge surface of the identification.

In some implementations, generating the identification document includes applying at least one of a kinegram film or a metalized hologram over the applied spectral feature to conceal the spectral feature; and using a YAG laser to de-metalize the kinegram film or metalized hologram to apply the particular type of line segment code and encode credential data about the individual.

In some implementations, the method further includes obtaining the credential data in response to analyzing excitation patterns of line code segments that fluoresce under particular light conditions. In some implementations, the method further includes performing, using a detector device, ablation of line code segments to read reflective light patterns associated with the line code segments and to extract the credential data in response to reading the reflective light patterns.

In some implementations, the method further includes reading, using the detector device, credential data encoded at the inner layer of the identification document. The credential data is read based on an angular placement of the detector device relative to the inner layer or relative to an edge of the identification document.

Other implementations of this and other aspects include corresponding systems, apparatus, and computer programs, configured to perform the actions of the methods, encoded on computer storage devices. A computing system of one or more computers or hardware circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 illustrates an example of an identification document with embedded line segment data.

FIG. 2 illustrates an example system for embedding information in a document or card.

FIG. 3 illustrates an example of a system for verifying an identification document based on data extracted from embedded line patterns of the identification document.

FIG. 4 shows a flow diagram of an example process for embedding information using one or more line segment coding features.

FIG. 5 shows a block diagram of a computing system that can be used in connection with computer-implemented methods described in this specification.

Like reference numbers and designations in the various drawings indicate like elements.

### DETAILED DESCRIPTION

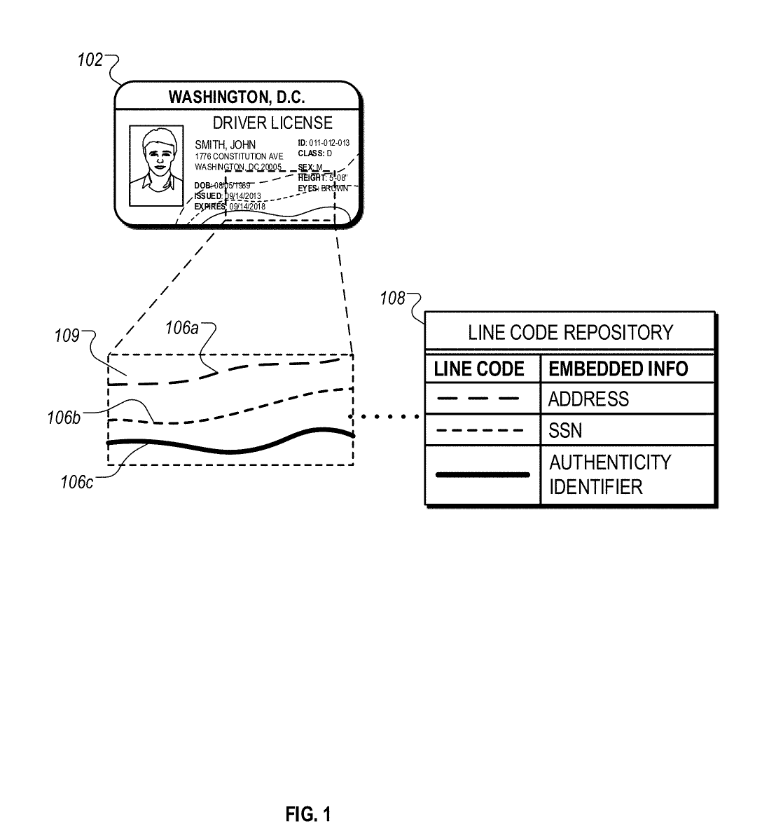

FIG. 1A illustrates an example of a physical identification document (e.g., an ID card) with line patterns embedded at a certain region/area of the document. In the example, identification/ID card 102 includes a customer photograph and embedded line patterns 106a, 106b, and 106c. Identification 102 is constructed such that different regions or areas of the identification article are outlined with different patterns. For example, line pattern 106a outlines a line pattern having a first spacing characteristic, line pattern 106b outlines a line pattern having a second spacing characteristic that differs from the first (i.e., smaller length), and line pattern 106c includes a solid line portion that can be used to indicate an authenticity identifier.

In some implementations, lines associated with a particular pre-print pattern can have certain line portions removed. The removed line portions therefore create an area/space 109 in which line segments associated with line code can be embedded. In some implementations, the line code can be configured in a curved manner that can be used to create outlines of particular patterns such as buildings, state capitals, state birds, or any other background pattern or image outline corresponding to a particular authority indicator/identifier for a given jurisdiction. In some implementations, the line patterns are used as part of the image data associated with an ID card. The line patterns can be used to securely embed encoded data that relate to identifying features of an individual.

Although the figure illustrates line patterns 106a-c being embedded within a physical identification, in other instances, the line patterns 106a-c can also be embedded within a digital identification (e.g., a digitally issued driver license). In addition, although the example depicted illustrates visibly detectable line patterns (e.g., visible to a human eye), in other instances, the line patterns can be constructed small enough to appear invisible to the human eye. In such instances, the line patterns can outline micro-features of a customer photograph (or other portions of the identification 102).

Each of the line patterns 106a, 106b, and 106c are distinctive from one another based on their line attributes. Examples of line attributes include the spacing of line segments within a pattern line, the length of the pattern line, the color of the pattern line, among others. As described above, the line pattern is also associated with a portion of secure customer information. The secure customer information can be identified within a line pattern repository 108 that includes mappings between each line pattern and corresponding secure customer information. As depicted, the line pattern 106a is mapped to customer address, the line pattern 106b is mapped to a social security number, and the line pattern 106c is mapped to an authenticity identifier.

The detection of the line patterns 106a-c and associated secure customer information can be used to verify the authenticity of the identification 102. As an example, verification data for the identification 102 can specify the line patterns 106a-c, the arrangement of the line patterns 106a-c within identification 102, and/or the associated credential information included within the line pattern repository 108. In this example, a detector device (described below) may compare detection data obtained from an identification presented by a customer to the verification data for the identification 102. For instance, if the detector device fails to detect each of the line patterns 106a-c, or detects an incorrect arrangement of the line patterns 106a-c, then the detector device may determine that the presented identification is a fraudulent ID card.

In another example, secure customer information obtained from the detected line patterns of a presented identification can be used to authenticate a customer in addition to the credential information specified by the identification (e.g., name, date of birth, address, etc.). In this example, line patterns can be included and/or embedded within the identification to securely authenticate a customer without exposing sensitive or personally identifiable information (e.g., social security number). In this regard, line pattern detection can be used to securely verify sensitive customer information.

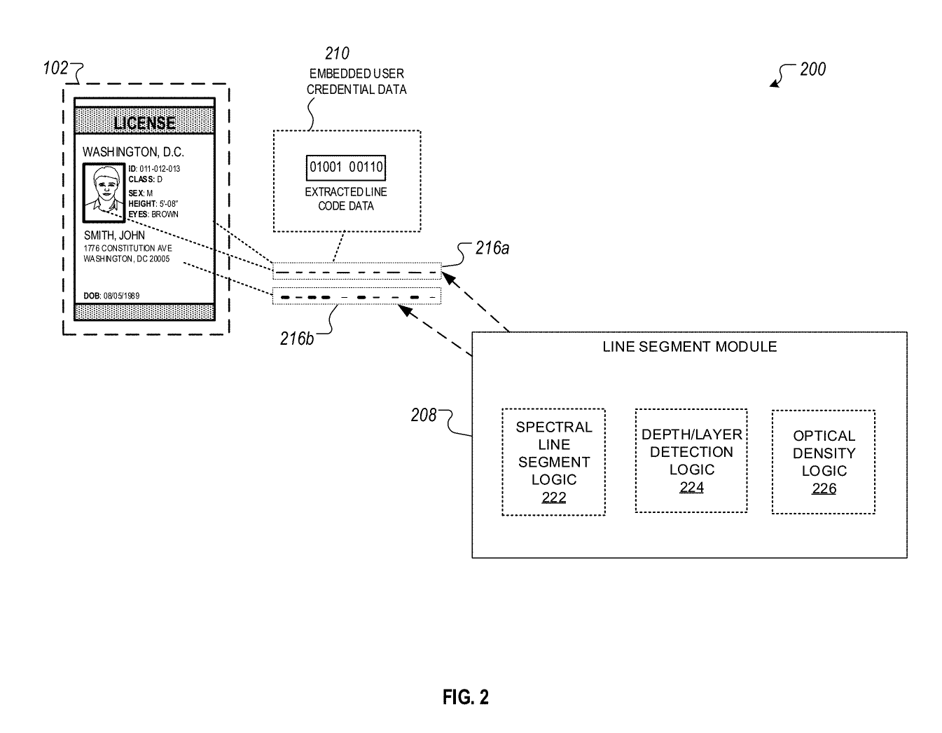

FIG. 2 illustrates an example system 200 for embedding information in an identification (ID) document 102 using different line segment code technologies. ID document 102 can be a digital or physical identification card that includes embedded line segments that are used to encode credential data for an individual. The credential data can be personally identifiable information about an individual, such as a person's social security number, address, date of birth, or driver's license number. As described in more detail below, the line patterns and line segments of the patterns can be created using combinations of different line code technology. For example, line patterns that include multiple line segments can be created and applied at ID document 102 using spectral line code technology, multi-layer line code technology, optical density line code technology, laser engraving/Lasink line code technology, or combinations of each.

System 200 includes a line segment module 208 that executes programmed instructions for applying line patterns at an ID document 102. In some implementations, module 208 is one of multiple devices that each interact to manufacture physical identification cards or to generate/create digital identification cards. As descried in more detail below, module 208 generally includes spectral logic 222, depth/layer logic 224, and optical density logic 226. Each of logic 222, 224, and 226 may correspond to computing devices or programmed code/software instructions for executing the spectral line code technology, multi-layer line code technology, and optical density line code technology, respectively. While in typical implementations, each of logic 222, 224, 226 is encoded on computer-readable media, in some implementations, these computing features are included within module 208 as a sub-system of hardware circuits that include one or more processing devices or processor microchips.

In general, module 208 can include processors, memory, and data storage devices that collectively form modules and computer systems of module 208. Processors of the computer systems process instructions for execution by module 208, including instructions stored in the memory or on the data storage device to display graphical information for output at an example display monitor of system 200. Execution of the stored instructions can cause one or more of the actions described herein to be performed by module 208. In other implementations, multiple processors may be used, as appropriate, along with multiple memories and types of memory. For example, module 208 may be connected with multiple other computing devices, with each device (e.g., a server bank, groups of servers, modules, or a multi-processor system) performing portions of the actions, operations, or logical flows described in this specification.

As used in this specification, and with reference to line segment module 208, the term “module” is intended to include, but is not limited to, one or more computers configured to execute one or more software programs that include program code that causes a processing unit(s)/device(s) of the computer to execute one or more functions. The term “computer” is intended to include any data processing or computing devices/systems, such as a desktop computer, a laptop computer, a mainframe computer, a personal digital assistant, a server, a handheld device, a smartphone, a tablet computer, an electronic reader, or any other electronic device able to process data.

Referring again to FIG. 2, module 208 is operable to leverage various line code technologies to create distinct types of line patterns that can be included at ID document 102. For example, module 208 can use spectral logic 222 to print line code (e.g., line patterns and corresponding line segments) in ultraviolet (UV) or general fluorescing colors. The line code can span multiple excitation wavelengths. In some implementations, logic 222 is used for frequency modulating the excitation wavelengths for multiple line code prints and patterns. For example, logic 222 can be used to generate line patterns at ID document 102 based on materials and features that exhibit different color attributes in response to excitation.

As described below, user credentials and other sensitive information can be obtained by recording or analyzing excitation patterns of line code/segments that fluoresce under certain light conditions. Hence, module 208 can be used to write or apply line code that includes line patterns/data that fluoresces when exposed to UV light rays, infrared (IR) light rays, or combinations of each. In some implementations, logic 222 is used to print line patterns and corresponding line segments using IR fluorescing pigments or dyes. Module 208 can be configured to vary the excitation wavelengths that correspond to line code applied at ID document 102. Module 208 is also operable to vary the spectral aspects of visible and IR and UV fluorescent wavelengths (spectra).

In general, line code that fluoresces under certain light conditions can be applied to ID document 102 in combination with other types of line code, such as optical density line code or Lasink laser line code. Hence, various types of spectral based line code can be printed on top of, or in combination with, existing visible line code patterns applied at ID document 102.

Module 208 can use depth/layer logic 224 to apply/write line code at different layers within a card structure. For example, logic 224 can be used to identify one or more layers of ID document 102, determine the type of line code and corresponding line pattern to applied to particular layers of document 102, and execute computing processes which cause the line code to be applied at a particular layer of ID document 102. In some implementations, logic 224 is used to apply line code to various layers of ID document 102 so as to maximize the amount of user credential data that can be encoded at the document. For example, module 208 can use an angular write mechanism (or read mechanism discussed below) to write line code data at the layers of an ID document 102.

System 100 can use module 208 to write line code (and read line code, using a decoder) at an edge of ID document 102. In some implementations, a card or document is shaped and configured to create edge features that are favorable for applying/writing line code data. For example, cuts or changes to edge contours of a card can be minimized in order to create edge features that are favorable for receiving line code. In some instances, edges of ID document 102 can be sensitized in order to create favorable edge features so that line segment data can be appropriately applied to the edge.

Line patterns and line segments (line code) applied to inner layers of ID document 102 may be positioned at a lower depth within the ID document 102 relative to line code applied at a surface of the document. As described in more detail below, a decoding device can be configured to read encoded line pattern data on the different layers of ID document 102. For example, the device can determine a depth of each layer of the ID document and then scan/analyze line pattern data included at the depth. In some implementations, system 200 can include a module or device that has an angular write/read mechanism for writing line code at inner layers (e.g., lower depths relative to a surface layer) of ID document 102 and reading line code applied to the inner layers.

Module 208 can leverage multiple types of line code technology to apply static spectral based line code (e.g., excitation from UV/IR light rays) as well as to apply line code to ID document 102 using laser etching/engraving processes (e.g., for a Lasink personalizing process). In some implementations, system 200 uses printing resources, such as dye diffusion thermal transfer (D2T2) or inkjet resources, to apply static spectral based line code to ID document 102. In other implementations, items and materials for generating line code associated with UV spectral features can be printed at a layer of ID document 102 and then blocked with kinegram/foil. For example, the materials can be printed at the layer and then blocked with kinegram/foil to etch away portions of the material in order to generate the line code.

Module 208 can use optical density logic 226 to add pixelation points of varying density between existing line segments. In some implementations, an ID document can include existing sets of line patterns (first line patterns) with line segments that are spaced apart. The first line segments can be generated using line code technology that differs from pixelation density increment technology. Techniques described in this document include using the spacing between the line segments of the first line patterns to embed additional data based on the added pixelation points. In some implementations, device 208 can select a range of density increments for the added pixelation points (e.g., between 0.4 and 2.0 OD, with increments from 0.4, 0.8, 1.2, 1.6 and 2.). In some instances, device 208 can use five levels of density so that each level is assigned a value and each value is easily discriminated from the other optical densities.

In general, line patterns can be based on differences in optical density (OD) (e.g., relative brightness) of pixels that depict data included in ID document 102. Line patterns that are created using this pixelation process can be embedded in an ID document or card (e.g., at a particular layer of the card) and are used to encode personal information based on density increment technology. Individual pixels are selected to carry data by assigning certain optical density levels that are ascribed to numerical or letter values. An increment of optical density is selected so that a computing device (e.g., a machine for reading/scanning data) can differentiate between various pixels that form line patterns based on their adjusted or incremented optical density.

Additionally, the pixels that form one or more line patterns can be placed in an array and arranged in a pattern to facilitate ease of “recognizing” and then subsequently “reading” encoded data represented by the pixels. For example, module 208 can use coded schemes to generate arrays of pixels that represent various line patterns. The arrays can be placed at specific locations of ID document 102 to facilitate identifying and interpreting encoded data ID document 102. In some implementations, module 209 causes pixels with assigned optical density values to be spaced apart by a predefined number of pixels (e.g., two to three pixels).

For a physical document 102, yttrium aluminum garnet (“YAG”) laser engraving can be used to generate line patterns that include separate pixels with gradations or increments in their optical density. The YAG laser implements a color laser image print process for generating a color photo on a physical document 102 by laser engraving. In some implementations, color pixilation can be used in addition to optical density. In other implementations, module 208 can be used to apply a metalized thin film at an area of ID document 102. The thin film can be a kinegram or metalized hologram that is applied over UV ink, IR ink, and other color inks. The thin film can cover and conceal the inks underneath. A YAG laser can be used to de-metalize the thin metal film based on a line code/line pattern format. By changing the line width and length in combination with the colors underneath the thin film, variable information can be encoded into the area of the ID card.

Module 208 can write line code within an existing line based on fixed or variable line spacing. For example, module 208 can write a line segment at 1.4 optical density and then write a different line segment at 1.9 optical density (e.g., a higher incremental optical density). The optical density should be increased with incremental line densities (regardless of color) so that an example decoding device or line code reader can distinguish between two different line segments. In some implementations, module 208 can also use a signal strength that correlates to the intensity and can super impose data using the UV/IR spectral features to generate line code as described above.

In some implementations, Lasink laser technology can be used to apply line code to layers of ID document 102 using one or more the processes described above (e.g., multi-layer line patterns or edge patterns). In other implementations, line code can be applied at one or more layers of a document using Lasink preprinted lines that have different color bands or wavelength bands. In some cases, various sets of spectral/UV based preprinted lines can be generated using the R, G, B color model (or visible C, Y, M lines). In these cases, line patterns can be applied to ID document 102 by using laser engraving with white UV fluorescing ink to cancel out certain colors and embed or encode credential data in the document.

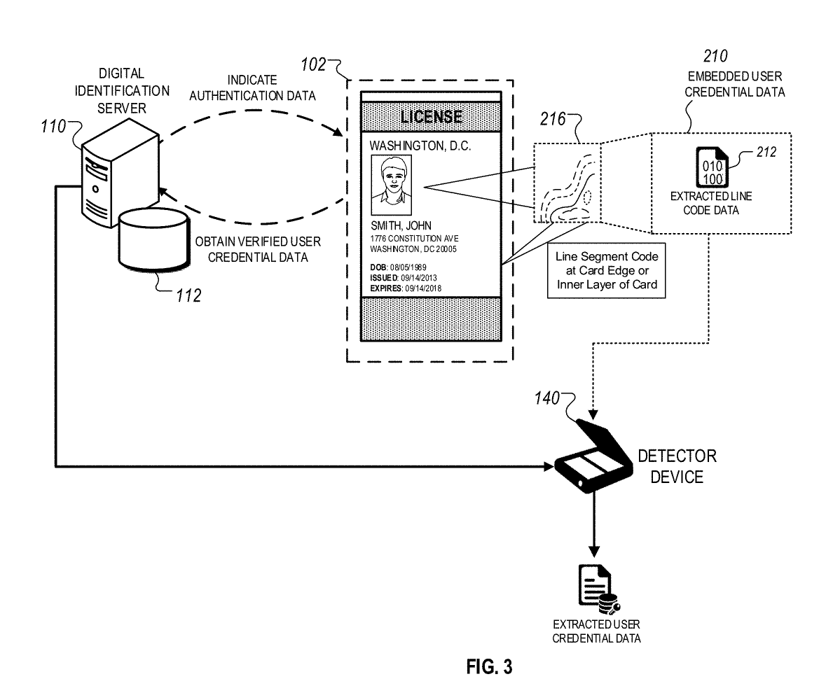

Using the described techniques, module 208 can create line patterns 216a and 216b, where the patterns are formed based on the different line code technology described above. For example, line pattern 216a can correspond to line patterns generated using logic 222 and having line segments with different spectral features or based on the above described Lasink laser engraving. Line pattern 216b can correspond to a line pattern with line segments that each have the same lengths but different optical densities. As shown at FIG. 3 (described below), line patterns 216 embedded at a physical or digital ID document can be formed using a series of lines that create the appearance of a wave going across the face of the ID document.

As shown, ID document 102 can include example line patterns 216a/b embedded in ID document 102 (e.g., at inner layers of a card or at edges of the card). As shown in FIG. 2, line patterns 216a/b correspond to encoded data that is scanned and used to generate an example binary data sequence that includes “01001 00110.” In some cases, more bits or fewer bits may be used, e.g., 2 bits to 1,000 bits. In some instances, encoded line data can be decoded, in part, by scanning or capturing an image of an example identification document. For example, the line data can be decoded using a computing device such as a smartphone, a digital camera, or a laptop computing device. The example binary data sequence can be processed using a detector device (e.g., detector device 140 described below) to authenticate the identification or to verify the identity of the card holder. Thus, line patterns embedded within an identification article can be scanned to extract and process encoded data to provide enhanced identification verification.

FIG. 3 illustrates an example of a system 300 for verifying an identification document based on data extracted from embedded line patterns of the ID document 102. Identification server 110 initially obtains secure customer information using different techniques. In some instances, the secure customer information may be obtained during the enrollment process when the customer is requested to verify his identity by providing personally identifiable information (e.g., social security number, user authentication information, etc.). The obtained customer information can then be stored and associated with designated line patterns.

Line pattern repository 108 maps specific line patterns that are embedded within the ID document 102 to pieces of secure information obtained by the identification server 110. The line pattern repository 108 thus enables the identification of a corresponding piece of secure customer information based upon the detection of an embedded line pattern within the ID document 102. The line pattern repository 108 may be stored in the digital identification database 112, and subsequently transmitted to authorized devices that perform verification of the ID document 102 such as a detector device 140.

During a verification operation of ID document 102, the detector device 140 initially scans or interprets line pattern data 212 within the ID document 102. This can be accomplished using various types of optical recognition techniques. For instance, the detector device 140 can be configured to recognize designated line patterns that are included within the line pattern repository 108. During a scan of the ID document 102, the detector device 140 may identify the presence of the designated line patterns, and extract the identified line patterns as the extracted line pattern data 212. The line pattern data 212 may specify a coordinate location (e.g., in an X,Y plane) within the digital or physical identification document where a particular line pattern was detected.

The detector device 140 can be configured to perform ablation of line patterns and line segments included at a credential surface or layer of ID document 102. For example, the detector device performs ablation of line patterns and line segments to read reflective light patterns associated with the line segments. As used herein, ablation relates to extracting data based on readings determined from analyzing reflecting light patterns. As described above, user credentials and other sensitive information can be obtained by recording or analyzing excitation patterns of line code/segments that fluoresce under certain light conditions. For example, decoder device 140 can obtain personally identifiable information that is encoded via line pattern data 212 by recording or analyzing excitation patterns of the line code features included in the document.

Decoding device 140 can be configured to read line code at different angles or based on the angular placement of the device 140 relative a layer or edge of ID document 102 that includes the line code. For example, when the decoding device is positioned at 0 degrees nominal, the device may not be able to read or interpret line code applied at a lower depth layer. However, when the decoding device is positioned at 45 degrees, the device can detect and interpret one or more types of line pattern data.

The detector device 140 can then obtain secure credential data assigned to the extracted or interpreted line pattern data 210 using the information specified within the line pattern repository 108. For instance, the detector device 140 may cross-reference each of the detected line patterns indicated by the extracted line pattern data 210 with the line patterns that are specified within the line pattern repository 108 in order to determine the pieces of personal or credential information assigned to each line pattern. The detector device 140 can verify the claimed identity based on the extracted credential information 212 to verify the authenticity of the ID document 102 as well as the identity of the cardholder. In some implementations, systems 200 or 300 can be used to create a registration mark or a pattern sensing device that is integrated at the document 102 to supplements the capture and read process. For example, if a curve (1/y) is being used then the x=1/y curve might prove useful as a registration mark.

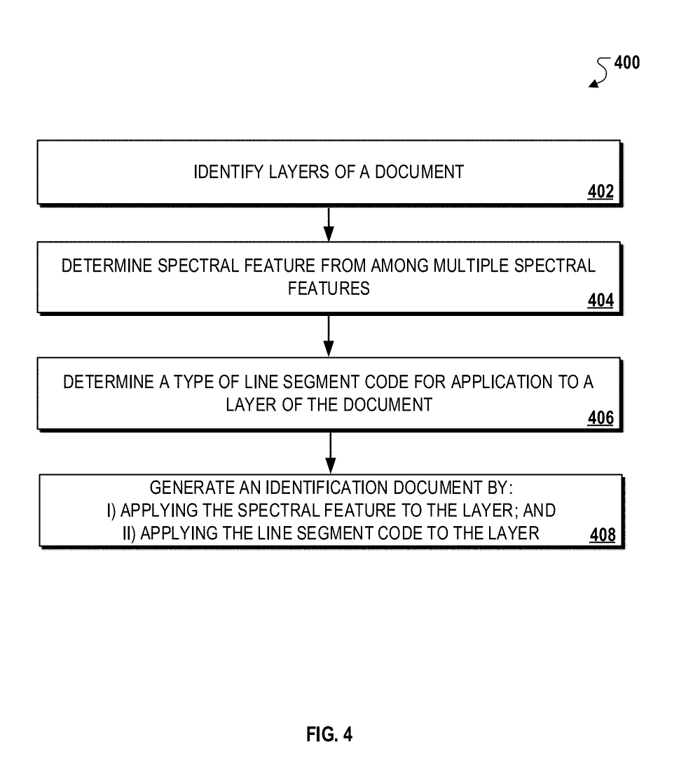

FIG. 4 shows a flow diagram of an example process 400 for embedding line segment data in an identification document. Process 400 can be implemented or executed using the systems and devices described above. In some implementations, the described actions of process 400 are enabled by computing logic or programmed instructions executable by processing devices and memory of computing resources described in this document.

Process 400 includes identifying one or more layers of a document (402). In some implementations, the document is a physical card that includes multiple layers and at least one layer of the multiple layers is an inner layer having a particular depth. For example, the inner layer can have a depth that is determined relative to at least one other layer of the multiple layers.

The process 400 further includes module 208 of system 200 determining a spectral feature from among multiple spectral features for application to the one or more layers of the document (404). For example, the spectral feature can be a UV spectral feature such as a UV or IR coloring or ink that can be applied or used to generate line code segments on a particular layer of an identification document. The process 400 includes module 208 of system 200 determining a particular type of line segment code for application to the one or more layers of the document (406). For example, the particular type of line segment code can be determined from among spectral line code technology, multi-layer line code technology, and optical density line code technology.

The line segment code is configured to encode credential data about an individual. For example, the line segment code can be spectral based line code that uses to particular type of color scheme or ink to encode the credential data. In some implementations, spectral line code exhibits fluorescent features when exposed to a particular type of light, such as UV light or IR light. In this manner, the encoded credential data can be obtained or extracted in response to exposing the document to the UV or IR light.

The process 400 includes generating an identification document by: i) applying the spectral feature; and ii) applying the particular type of line segment code to the inner layer having the particular depth (408). The particular depth is determined relative to at least one other layer of the document. For example, the particular depth can be determined relative to a surface layer of the document.

In some implementations, applying the spectral feature includes: applying the spectral feature at an edge of the identification document to create an edge feature based on an edge contour and an edge cut of the identification document. Generating the identification document includes sensitizing an edge of the identification document to create a sensitized edge surface that is conditioned to receive the spectral feature. Module 208 can then use logic 222 to apply the spectral feature and the particular type of line segment code (e.g., spectral line code) to the sensitized edge surface of the identification.

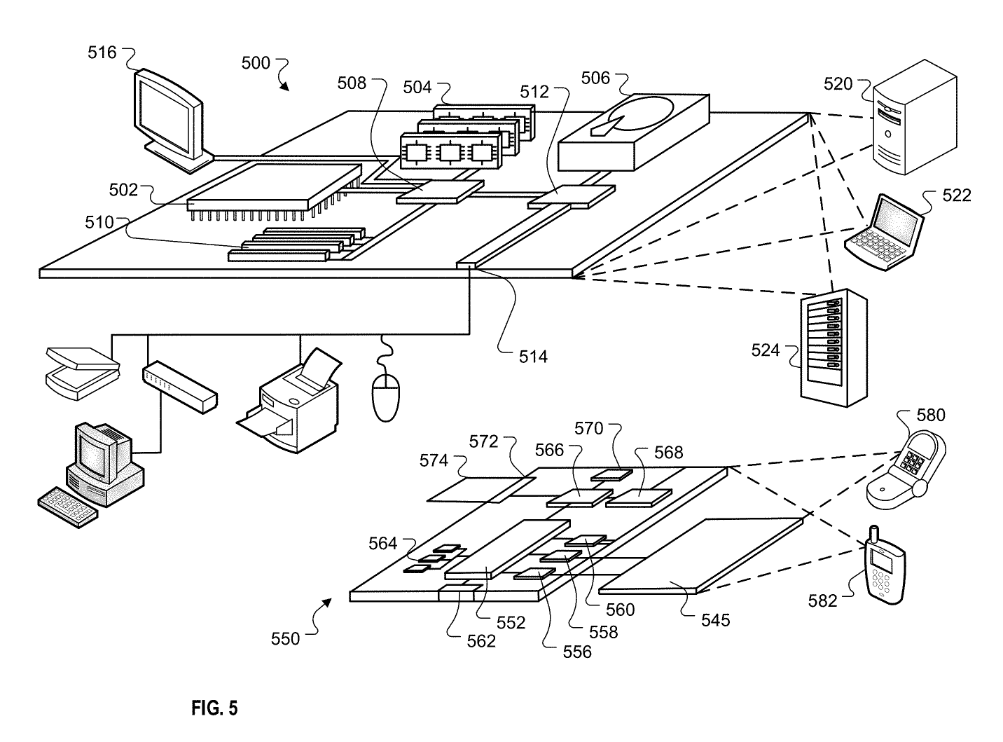

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations, e.g., as a server bank, a group of blade servers, or a multi-processor system.

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is exemplary only. In one implementation, the high-speed controller 508 is coupled to memory 504, display 516, e.g., through a graphics processor or accelerator, and to high-speed expansion ports 510, which may accept various expansion cards (not shown). In the implementation, low-speed controller 512 is coupled to storage device 506 and low-speed expansion port 514. The low-speed expansion port, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may include appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication, e.g., via a docking procedure, or for wireless communication, e.g., via Bluetooth or other such technologies.

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provided as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound, e.g., voice messages, music files, etc., and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back-end component, e.g., as a data server, or that includes a middleware component such as an application server, or that includes a front-end component such as a client computer having a graphical user interface or a Web browser through which a user can interact with an implementation of the systems and techniques described here, or any combination of such back-end, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, certain data may be treated in one or more ways before it is stored or used, so that personally identifiable information is removed. For example, in some embodiments, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A number of embodiments have been described. Nevertheless, it will be understood that various modifications may be made without departing from the spirit and scope of the invention. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method, comprising:
identifying one or more layers of a document, where at least one layer is an inner layer having a particular depth;
determining a spectral feature from among multiple spectral features for application to the one or more layers of the document;
determining a particular type of line segment code for application to the one or more layers of the document, the line segment code being configured to encode credential data about an individual; and
generating an identification document by:
i) applying the spectral feature; and
ii) applying the particular type of line segment code to the inner layer having the particular depth, wherein the particular depth is determined relative to at least one other layer of the document.

2. The method of claim 1, wherein applying the spectral feature comprises:
applying the spectral feature at an edge of the identification document to create an edge feature based on an edge contour and an edge cut of the identification document.

3. The method of claim 2, wherein generating the identification document comprises:
sensitizing an edge of the identification document to create a sensitized edge surface that is conditioned to receive the spectral feature; and
applying the spectral feature and the particular type of line segment code to the sensitized edge surface of the identification.

4. The method of claim 1, wherein generating the identification document comprises:
applying at least one of a kinegram film or a metalized hologram over the applied spectral feature to conceal the spectral feature; and
using a YAG laser to de-metalize the kinegram film or metalized hologram to apply the particular type of line segment code and encode credential data about the individual.

5. The method of claim 1, further comprising:
obtaining the credential data in response to analyzing excitation patterns of line code segments that fluoresce under particular light conditions.

6. The method of claim 5, further comprising:
performing, using a detector device, ablation of line code segments to read reflective light patterns associated with the line code segments and to extract the credential data in response to reading the reflective light patterns.

7. The method of claim 6, further comprising:
reading, using the detector device, credential data encoded at the inner layer of the identification document, wherein the credential data is read based on an angular placement of the detector device relative to the inner layer or relative to an edge of the identification document.

8. A system, comprising:
one or more processing devices; and
one or more non-transitory machine-readable storage devices storing instructions that are executable by the one or more processing devices to cause performance of operations comprising:
identifying one or more layers of a document, where at least one layer is an inner layer having a particular depth;
determining a spectral feature from among multiple spectral features for application to the one or more layers of the document;
determining a particular type of line segment code for application to the one or more layers of the document, the line segment code being configured to encode credential data about an individual; and
generating an identification document by:
i) applying the spectral feature; and
ii) applying the particular type of line segment code to the inner layer having the particular depth, wherein the particular depth is determined relative to at least one other layer of the document.

9. The system of claim 8, wherein applying the spectral feature comprises:
applying the spectral feature at an edge of the identification document to create an edge feature based on an edge contour and an edge cut of the identification document.

10. The system of claim 9, wherein generating the identification document comprises:
sensitizing an edge of the identification document to create a sensitized edge surface that is conditioned to receive the spectral feature; and
applying the spectral feature and the particular type of line segment code to the sensitized edge surface of the identification.

11. The system of claim 8, wherein generating the identification document comprises:
applying at least one of a kinegram film or a metalized hologram over the applied spectral feature to conceal the spectral feature; and
using a YAG laser to de-metalize the kinegram film or metalized hologram to apply the particular type of line segment code and encode credential data about the individual.

12. The system of claim 8, wherein the operations further comprise:
obtaining the credential data in response to analyzing excitation patterns of line code segments that fluoresce under particular light conditions.

13. The system of claim 12, wherein the operations further comprise:
performing, using a detector device, ablation of line code segments to read reflective light patterns associated with the line code segments and to extract the credential data in response to reading the reflective light patterns.

14. The system of claim 13, wherein the operations further comprise:
reading, using the detector device, credential data encoded at the inner layer of the identification document, wherein the credential data is read based on an angular placement of the detector device relative to the inner layer or relative to an edge of the identification document.

15. One or more non-transitory machine-readable storage devices storing instructions that are executable by one or more processing devices to cause performance of operations comprising:
identifying one or more layers of a document, where at least one layer is an inner layer having a particular depth;
determining a spectral feature from among multiple spectral features for application to the one or more layers of the document;
determining a particular type of line segment code for application to the one or more layers of the document, the line segment code being configured to encode credential data about an individual; and
generating an identification document by:
i) applying the spectral feature; and
ii) applying the particular type of line segment code to the inner layer having the particular depth, wherein the particular depth is determined relative to at least one other layer of the document.

16. The machine-readable storage devices of claim 15, wherein applying the spectral feature comprises:
applying the spectral feature at an edge of the identification document to create an edge feature based on an edge contour and an edge cut of the identification document.

17. The machine-readable storage devices of claim 16, wherein generating the identification document comprises:
sensitizing an edge of the identification document to create a sensitized edge surface that is conditioned to receive the spectral feature; and
applying the spectral feature and the particular type of line segment code to the sensitized edge surface of the identification.

18. The machine-readable storage devices of claim 15, wherein generating the identification document comprises:
applying at least one of a kinegram film or a metalized hologram over the applied spectral feature to conceal the spectral feature; and
using a YAG laser to de-metalize the kinegram film or metalized hologram to apply the particular type of line segment code and encode credential data about the individual.

19. The machine-readable storage devices of claim 15, wherein the operations further comprise:
obtaining the credential data in response to analyzing excitation patterns of line code segments that fluoresce under particular light conditions.

20. The machine-readable storage devices of claim 19, wherein the operations further comprise:
performing, using a detector device, ablation of line code segments to read reflective light patterns associated with the line code segments and to extract the credential data in response to reading the reflective light patterns; and
extracting, using the detector device, credential data encoded at the inner layer of the identification document, wherein the credential data is extracted based on an angular placement of the detector device relative to the inner layer or relative to an edge of the identification document.
